(19) United States
(12) Patent Application Publication
(10) Pub. No.: US 2014/0115637 A1
(43) Pub. Date: Apr. 24, 2014

(54) SYSTEM AND METHOD FOR BROADCAST RECEPTION MANAGEMENT

(71) Applicant: SPECTRUM BRIDGE, INC., Lake Mary, FL (US)

(72) Inventor: Peter Stanforth, Winter Springs, FL (US)

(73) Assignee: SPECTRUM BRIDGE, INC., Lake Mary, FL (US)

(21) Appl. No.: 13/658,089

(22) Filed: Oct. 23, 2012

(51) Int. Cl. H04N 21/65

(52) U.S. Cl. 725/62

(57) ABSTRACT

A system and method for broadcast reception management. In some embodiments, a database may provide information for advising a wireless electronic device of the accessible channels on which content is provided over licensed and/or unlicensed spectrum for a given location, as well as the associated channel numbers for the channels. By using the database, the wireless electronic device may identify the accessible channels and associated channel numbers for a given location without having to perform a scanning and identification process. In other embodiments, the database may provide information for advising a content management device of an available broadcast resource on which the content management device may effectuate broadcast of content to the wireless electronic device.

### TECHNICAL FIELD

The technology of the present disclosure relates generally to wireless communications and, more particularly, to a system and method for broadcast reception management.

### BACKGROUND

The portability of wireless electronic devices is becoming increasingly prevalent, due much in part to their reduction in size and/or integration with other devices. Some wireless electronic devices may include a digital television tuner to wirelessly receive digital television and/or a radio tuner to wirelessly receive analog or digital radio broadcasts. Wireless electronic devices that receive such broadcasts scan the appropriate spectrum for accessible channels (broadcast bands that include receivable signals) in the present location of the wireless electronic device. When a digital TV broadcast is identified on a channel, the wireless electronic device identifies the channel number (actual and/or virtual) associated therewith. However, the scanning and identification process is time consuming and must be performed each time the wireless electronic device is moved to a new location.

### BRIEF DESCRIPTION OF THE DRAWINGS

FIG. 1 is a schematic view of an exemplary transmitter.

FIGS. 2-4 are schematic views of exemplary arrangements of transmitters.

FIG. 5 is a schematic view of an exemplary broadcast reception management system.

FIG. 6 is a schematic view of an exemplary wireless electronic device.

FIG. 7 is a schematic view of an exemplary content management device.

FIGS. 8 and 9 are flow diagrams representing exemplary actions taken by various components of the broadcast reception management system of FIG. 5.

### DETAILED DESCRIPTION

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

### A. INTRODUCTION

In the U.S., the Federal Communications Commission (FCC) has eliminated analog television (TV) broadcasts in favor of digital TV broadcasts. TV stations now broadcast using digital signals using UHF broadcast bands and VHF broadcast bands in the frequency range of 54 MHz to 698 MHz.

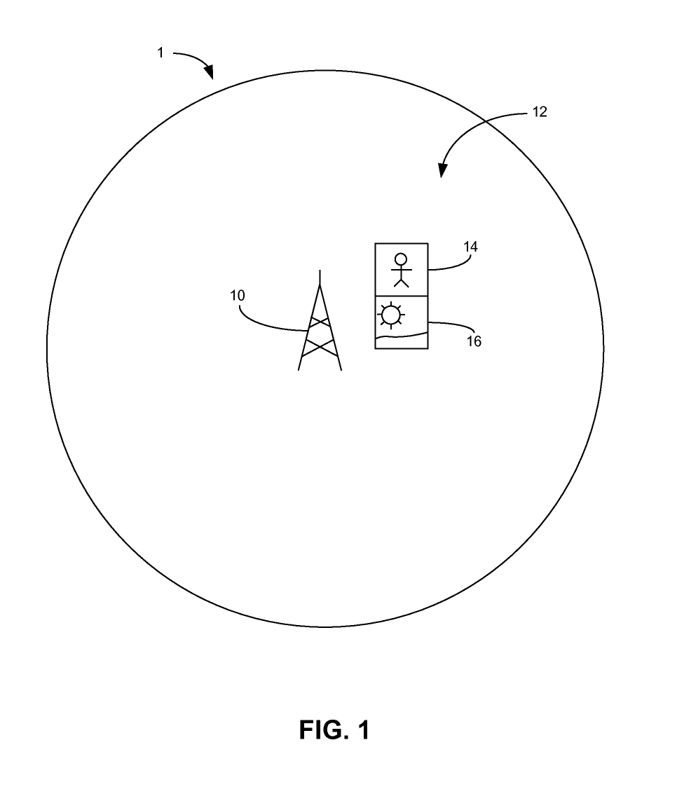

Some digital TV broadcasts are still broadcast by a broadcaster 1 in a manner similar to that by which analog TV broadcasts were broadcast. As exemplified in FIG. 1, this traditional TV broadcast model is based on a single high-power, high-site, transmitter 10 that has a predetermined broadcast area 12. This model permits the broadcast of a single or multiple content streams over a given channel. In the present disclosure the term “channel” encompasses a broadcast band (e.g., a UHF TV band, a VHF TV band, a FM radio band, an AM radio band, etc.), as well as one or more sub-channels included as part of a multiplex associated with the broadcast band. In the example shown in FIG. 1, the transmitter 10 digitally broadcasts a primary content 14, as well as a secondary content 16 using a multiplex transmission on a channel used by the transmitter. The same content (primary and secondary) is received by all digital TV and/or mobile digital TV viewers in the predetermined broadcast range 12 that tune to the channel used by the transmitter 10.

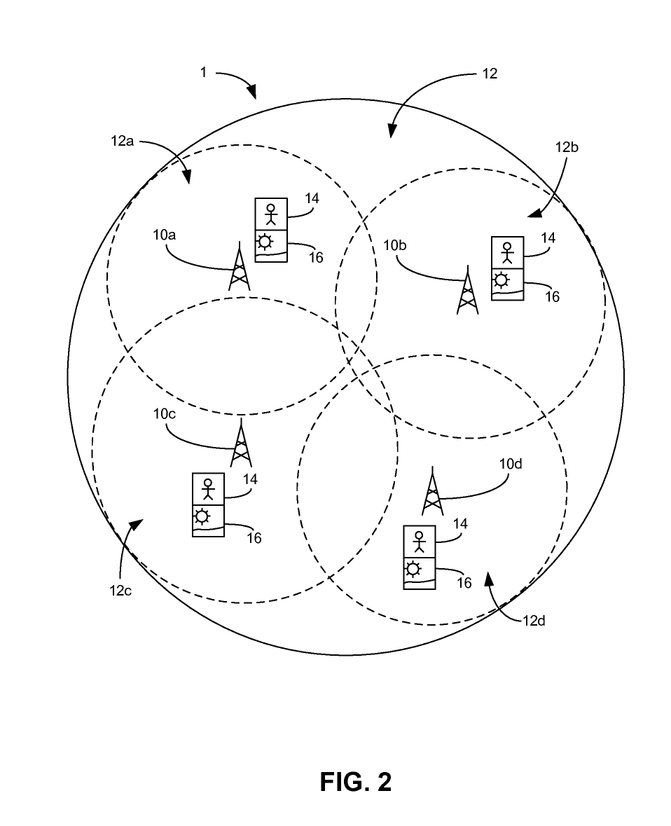

An alternative to the above-described traditional broadcast model is the Distributed Transmission System (DTS) model. As exemplified in FIG. 2, the single broadcast transmitter is replaced with a number of low antenna height, low-power transmitters 10a-10d having respective predetermined broadcast areas 12a-12d that, when used collectively, serve substantially the same area 12 that is served using the traditional model (FIG. 1). In accordance with the DTS model, a broadcaster 1 may utilize a distributed transmission adapter (not shown) to synchronize the digital TV broadcast over a given channel using the respective transmitters 10a-10d as distributed transmission slaves. In the example shown in FIG. 2, each transmitter 10a-10d broadcasts the same primary content 14, as well as the same secondary content 16 if secondary content is also broadcast. The DTS model is often regarded as a more efficient way of providing coverage compared to a single, high-power transmitter. However, the DTS model is not widely deployed because of potential interference issues between the respective transmitters and the reliance on legacy high-power transmitters.

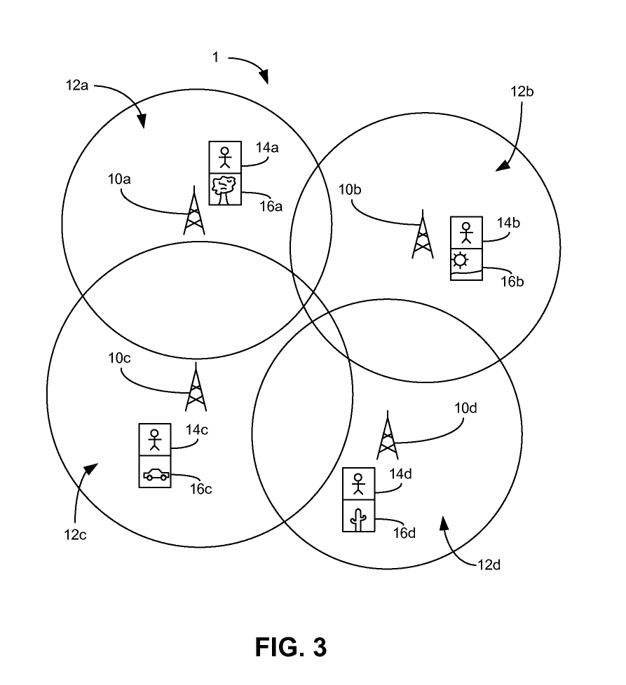

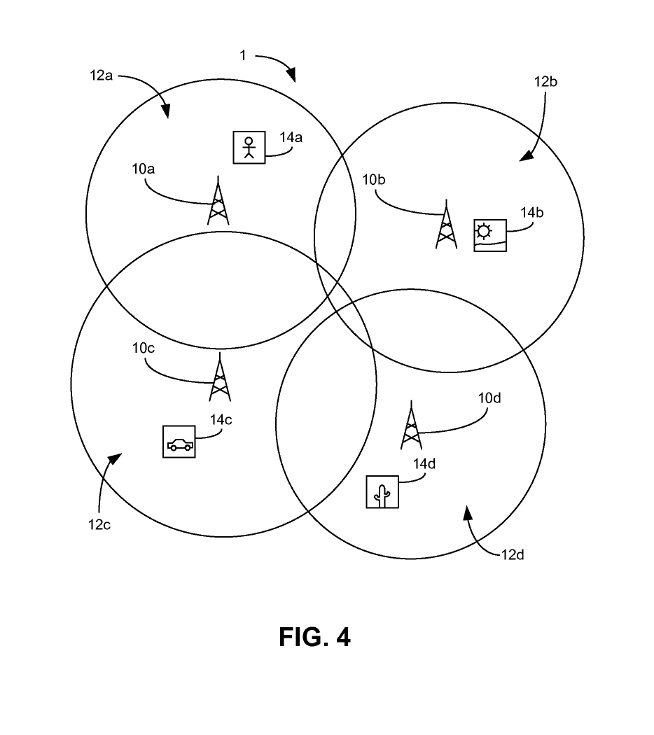

The inventors of the present application have realized that broadcasters 1 may adapt the DTS concept into a cellular-like distribution system where different content is locally broadcast using these low antenna height, low-power transmitters 10a-10d, the content having context to the specific localized broadcast location. FIGS. 3 and 4 shows examples of digital TV broadcast using cellular-like distribution system. In the embodiment shown in FIG. 3, the transmitters 10a-10d broadcast the same primary content 14, and broadcast different secondary content 16a-16d on their respective sub multiplexes (e.g., as a result of the ability for each transmitter 10a-10d to broadcast in multiplex). In the embodiment shown in FIG. 4, each transmitter broadcasts its own respective primary content 14a-14d. Although not specifically shown in FIG. 4, each transmitter may additionally broadcast its own respective secondary content. In the embodiment shown in FIG. 4, the transmitters 10a-10d are not required to be synchronized.

For the embodiments of the cellular-like distribution system exemplified in FIGS. 3 and 4, the specific content of a broadcast may be highly localized. For example, the language in which a particular content is broadcast may be localized based on demographic information. In another example, the localized content may be specific to a particular location, such as the broadcast of a sporting event within the sports stadium, the broadcast of specific promotional materials within a shopping center or theme park, the broadcast of a navigation information within the confines of a university or medical campus, the broadcast of flight information in an airport, etc.

In addition to localized broadcast over licensed spectrum, content may be locally broadcast over unlicensed TV white space (TVWS). The elimination of analog television (TV) broadcasts in favor of digital TV broadcasts has freed spectrum for use by unlicensed radio systems to offer various services, such as TV and radio broadcast, and Internet access. In the case of TV white space, the white space is comprised of unused TV spectrum in the frequency range of 54 MHz to 698 MHz.

Accordingly, when taking into consideration the various avenues of broadcast over both licensed and unlicensed spectrum, there is the possibility of dozens if not hundreds of unique broadcasts for a given location. Furthermore, it is likely that the content of these broadcasts will vary from location to location.

Conventionally, channels (broadcast bands) for analog TV transmissions were ordered by channel number as the bands increased in frequency. But for digital broadcast over these same channels (both licensed and unlicensed), the channel numbers may not be numbered in order according to frequency. Therefore, devices that receive digital broadcasts scan the spectrum for accessible channels, and will identify the accessible channels and associated channel numbers received by the device. In the present disclosure the term “accessible channel” encompasses a channel (broadcast band) on which a receivable signal is broadcast, the channel having a signal strength (predicted or actual) above a predetermined threshold signal strength at the location of the wireless electronic device that is high enough to effectively receive and decode the content of the broadcast.

This scanning and identification process is time consuming and is inappropriate for use in connection with mobile devices, particularly in view of the potential for highly-localized broadcasts. Such devices must perform the process each time it is moved to a new location. For example, a wireless electronic device that has performed the scanning and identification process in a first location must perform another scanning and identification process when moved to a second location.

In accordance with the present disclosure, a database may provide information for advising the wireless electronic device of the channels on which content is provided over licensed spectrum, unlicensed spectrum, or both licensed spectrum and unlicensed spectrum for a given location, as well as the associated channel numbers for the channels. By using the database, the wireless electronic device may identify the accessible channels and associated channel numbers for a given location without having to perform the scanning and identification process.

Alternatively or in addition, the database may provide information for advising a content management device of an available broadcast resource (e.g., a transmitter and spectrum) through which the content management device may effectuate broadcast of content to the wireless electronic device.

The above example describes a digital TV broadcast. However, aspects of the disclosed systems and methods are independent of the type of digital or analog broadcast received by a wireless electronic device. It will be appreciated that the techniques described in this document may apply to other forms of broadcast over any suitable form of licensed or unlicensed spectrum (e.g., digital or analog radio broadcast).

### B. BROADCAST RECEPTION MANAGEMENT SYSTEM

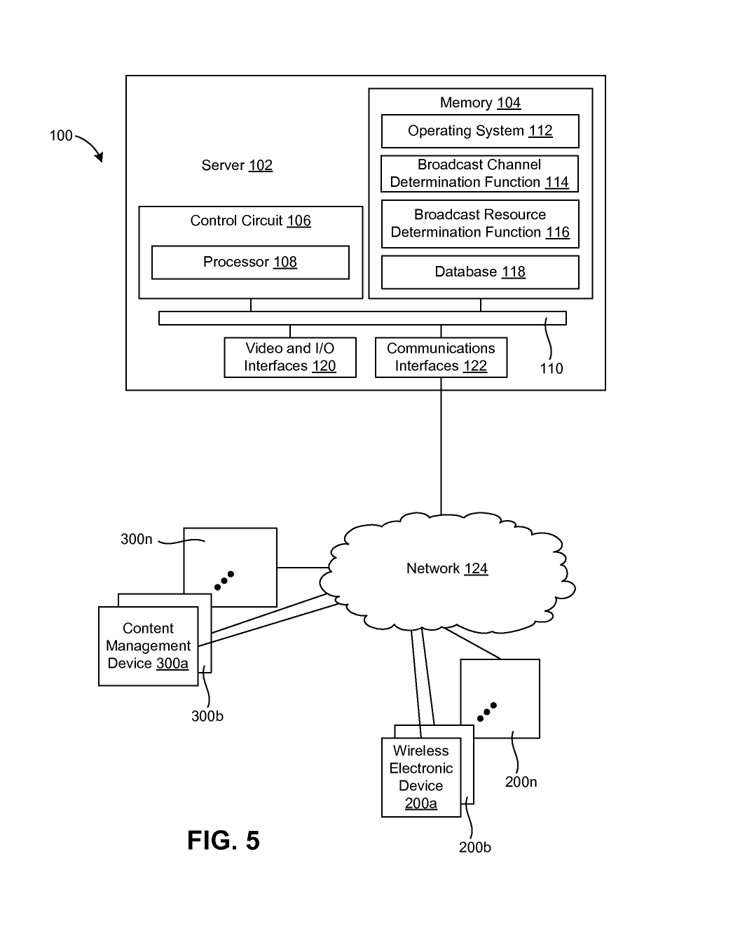

Referring now to FIG. 5, a schematic block diagram of a broadcast reception management system is shown at 100. The broadcast reception management system 100 includes a computer-based server 102.

The server 102 may be configured to execute various functions for providing a wireless electronic device with information regarding accessible channels on which content is provided over licensed and/or unlicensed spectrum at a location of the wireless electronic device. As discussed in more detail below, in some embodiments, the server 102 may be configured to receive a channel request from a wireless electronic device, determine a list of accessible channels and associated channel numbers for the location of the wireless electronic device by searching the database stored on the server, and transmit a channel response including a list of accessible channels and associated channel numbers to the wireless electronic device. Such features allow for the wireless electronic device to generate a channel map of accessible channels without having to scan the spectrum.

The server 102 may alternatively or additionally be configured to execute various functions for providing a content management device with information regarding an available broadcast resource (e.g., a transmitter and spectrum) though which the content management device may effectuate broadcast of content to the wireless electronic device. In one embodiment, the server 102 may be configured to receive a resource request from a content management device, determine an available broadcast resource proximate the location of a wireless electronic device by searching the database stored on the server and/or by communication with a broadcaster associated with the broadcast resource and arranging use of the broadcast resource on behalf of the content management device, and transmit a resource response including identification of the available broadcast resource to the content management device. Such features allow for the content management device to provide content to a wireless electronic device using a localized broadcast.

The server 102 may include a memory 104 for storing data, logic routine instructions, computer programs, files, operating system instructions, and the like. The memory 104 is considered a non-transitory computer readable medium and may comprise several devices, including volatile and non-volatile memory components. Accordingly, the memory 104 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the server 102 may be controlled by a control circuit 106. The control circuit 106 may include one or more processors 108 used to execute instructions that carry out a specified logic routine(s). The control circuit 106 and the components of the memory 104 may be coupled using a local interface 110. The local interface 110 may be, for example, a data bus with accompanying control bus, a network, or other subsystem.

The memory 104 may store an operating system 112 that is executed by the processor 108 to control the allocation and usage of resources in the server 102, as well as provide basic user interface features. Specifically, the operating system controls the allocation and usage of the memory 104, the processing time of the processor 108 dedicated to various applications being executed by the processor 108, and the peripheral devices, as well as performing other functionality. In this manner, the operating system 112 serves as the foundation on which applications, such as the broadcast channel determination function 114 and/or the broadcast resource determination function 116, depend as is generally known by those with ordinary skill in the art. The operating system 112 also may control much of the user interface environment presented to a user, such as features of the overall graphical user interface (GUI) for the system.

The memory 104 may store a broadcast channel determination function 114. In one embodiment, the broadcast channel determination function 114 is embodied as one or more computer programs (e.g., one or more software applications including compilations of executable code).

The broadcast channel determination function 114 may be configured to provide a wireless electronic device 200 with information about the accessible channels on which content is provided over licensed and/or unlicensed spectrum for a given location. For a given channel, such information may include the associated broadcast band (frequency) and associated channel number. Such information may additionally include, for example, network affiliation, genre information, type of broadcast (e.g., licensed spectrum, unlicensed spectrum, mobile TV standard, or fixed TV standard), bibliographic information (e.g., name of the content being broadcast, length, description), etc. The broadcast channel determination function 114 may be configured to determine the accessible channels and associated channel numbers for the given location in response to a request from a wireless electronic device 200. In an example, the broadcast channel determination function 114 may determine the accessible channels and associated channel numbers based on information received from the wireless electronic device 200 with the request, such as the location of the wireless electronic device, identification of the wireless electronic device 200, specification(s) of the wireless electronic device 200, etc. Exemplary embodiments showing the operation of the broadcast channel determination function 114 are described in more detail below.

The memory 104 may store a broadcast resource determination function 116. In one embodiment, the broadcast resource determination function 116 may be embodied as one or more computer programs (e.g., one or more software applications including compilations of executable code).

The broadcast resource determination function 116 may be configured to provide a content management device with information regarding an available broadcast resource (e.g., a transmitter and spectrum) though which the content management device may effectuate broadcast of content to the wireless electronic device. Such process may be separate from the process of providing a wireless electronic device 200 with information about the accessible channels on which content is provided over licensed and/or unlicensed spectrum for a given location (e.g., as provided by the broadcast channel determination function 114), and may be performed independent therefrom, prior thereto, or concurrent therewith. The broadcast resource determination function 116 may be configured to determine an available broadcast resource proximate the location of a wireless device in response to a request from the content management device. In an example, the broadcast resource determination function 116 may determine an available broadcast resource based on information received with the request, such as the location of the wireless electronic device, identification of the wireless electronic device 200, specification(s) of the wireless electronic device 200, etc. Such determination may be made by searching the database 118 and/or by communication with a broadcaster 1 associated with the broadcast resource and arranging use of the broadcast resource on behalf of the content management device. The features of the broadcast resource determination function 116 may be suitable for use in connection with on-demand and/or permission-based (e.g., subscription or pay-per-view) broadcasts. Exemplary embodiments showing the operation of the permission management function 116 are described in more detail below.

The memory 104 may store a database 118 that stores information used by the broadcast channel determination function 114 and/or the broadcast resource determination function 116. The database 118 may include a list of channels that are transmitted over licensed and/or unlicensed spectrum, as well as information pertaining to each channel. Such information may include the channel (frequency), channel number (actual or virtual), network affiliation, genre information, type of broadcast (e.g., licensed spectrum, unlicensed spectrum, mobile TV standard, or fixed TV standard), bibliographic information, geographic coverage area, data regarding transmission characteristics of the transmitter for each broadcast (e.g., transmit power antenna height, antenna profile), etc. Additionally or alternatively, the database may include a list of broadcasters and associated available broadcast resources configured to broadcast content to the wireless electronic device 200, as well as information pertaining to each broadcaster and/or available broadcast resource. Such information may include the channel (frequency), channel number (actual or virtual), type of broadcast, geographic coverage area, data regarding transmission characteristics of the transmitter for each broadcast (e.g., transmit power antenna height, antenna profile), etc. In addition to the above, the database 118 may include data regarding reception capabilities of the electronic device 200, such as antenna gain, tuning range in terms of frequency, etc. This information may be used to determine predicted receive signal strengths of the broadcasts.

In some embodiments, the database 118 may be compiled, in part, using data from a conventional TVWS database and registration system. The purpose of conventional TVWS database and registration is to determine stations that may be used by a television band radio device (TVBD) for wireless communications. The information pertaining to the TV transmitters from the conventional TVWS database can be included in the database 118 in order to provide channel information for respective broadcast stations. The information pertaining to the available broadcast spectrum can be included in the database 118 in order to provide available broadcast resource information. The database 118 may be supplemented with information related to the respective transmitters, e.g., network affiliations, genre, broadcast schedules, signal strength data provided from the wireless electronic device 200, type of broadcast (e.g., mobile TV standard or fixed TV standard), and/or data from content management source such as the Federal Communications Commission (FCC).

The server 102 may have various video and input/output (I/O) interfaces 120 as well as one or more communications interfaces 122. The I/O interfaces 120 may be used to operatively couple the server 102 to various peripherals (not shown), such as a display, a keyboard, a mouse, and/or one or more other suitable input devices. The communications interfaces 122 may include for example, a modem and/or a network interface card. The communications interfaces 122 may enable the server 102 to send and receive data signals, voice signals, video signals, and the like to and from one or more wireless electronic devices 200a-200n via an external network 124 (e.g., the Internet, a wide area network (WAN), a local area network (LAN), direct data link, or similar systems). The communications interfaces 122 may additionally or alternatively enable the server 102 to send and receive data signals, voice signals, video signals, and the like to and from one or more content management devices 300a-300n via the external network 124.

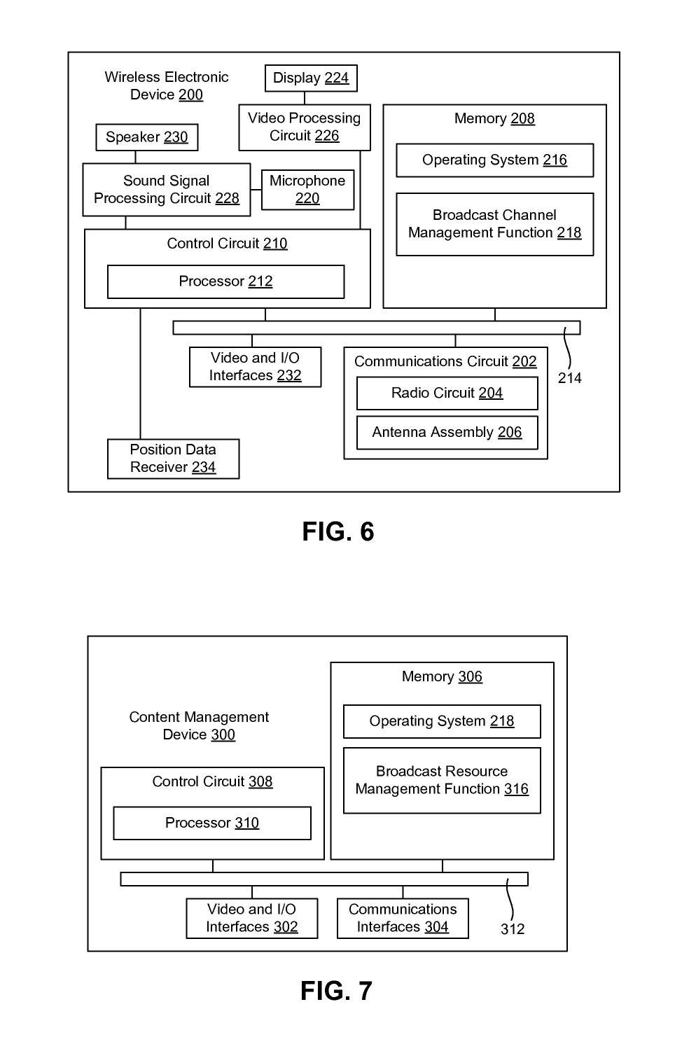

FIG. 6 is a schematic view of an exemplary wireless electronic device 200 illustrated in FIG. 5. As discussed in more detail below, the wireless electronic device 200 may be configured to execute various functions for broadcast reception management.

In some embodiments, the wireless electronic device 200 may be configured to transmit a channel request to the server including the location of the wireless electronic device, receive a channel response from the server including a list of accessible channels and respective associated channel numbers, and generate a channel map using the list of accessible channels and associated channel numbers. Such features allow for the wireless electronic device 200 to identify the accessible channels on which content is provided over licensed and/or unlicensed spectrum at the location of the wireless electronic device without having to perform the scanning and identification process.

In other embodiments, the wireless electronic device 200 may be configured to transmit a broadcast request to a content management device including the location of the wireless electronic device, receive a broadcast response from the content management device including identification of a channel on which the content will be broadcast to the wireless electronic device, and tune to the identified channel. Such features allow for the wireless electronic device 200 to receive content (e.g., on-demand content or permission-based content) from a content management device using localized broadcast.

The wireless electronic device 200 may be a personal portable device such as, for example, a laptop computer, mobile phone (e.g., smart phone), tablet, media player, gaming device, personal digital assistant (PDA), electronic book reader, standalone device, etc. Other examples of the wireless electronic device 200 include stationary devices such as television or desktop computer.

The wireless electronic device 200 may include communications circuitry 202. In the illustrated exemplary embodiment, as part of the communications circuitry 202, the wireless electronic device 200 includes a radio circuit 204 and an antenna assembly 206. The communications circuitry 202 may be used to carry out various wireless communications functions, including receiving a digital broadcast and communicating with the server 102 and/or the content management device 300.

The illustrated radio circuitry 204 and antenna assembly 206 represents one or more than one radio transceiver to enable the wireless electronic device 200 to be able to communicate and receive signals over various types of network connections and/or protocols. In one embodiment, the communications circuitry 202 includes one or more broadcast tuners, such as a digital TV tuner, an FM radio tuner, an AM radio tuner, a digital radio tuner, etc, as well as a transceiver capable of establishing backchannel communication with the server 102, such as a cellular communications transceiver, or a packet-switched communications transceiver (e.g., Wi-Fi or WiMAX).

The wireless electronic device 200 may include a memory 208 for storing data, logic routine instructions, computer programs, files, operating system instructions, and the like. The memory 208 is considered a non-transitory computer readable medium and may comprise several devices, including volatile and non-volatile memory components. Accordingly, the memory 208 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the wireless electronic device 200 may be controlled by a control circuit 210. The control circuit 210 may include one or more processors 212 used to execute instructions that carry out a specified logic routine(s). The control circuit 210 and the components of the memory 208 may be coupled using a local interface 214. The local interface 214 may be, for example, a data bus with accompanying control bus, a network, or other subsystem.

The memory 208 may store an operating system 216 that is executed by the processor 212 to control the allocation and usage of resources in the wireless electronic device 200, as well as provide basic user interface features. Specifically, the operating system 216 controls the allocation and usage of the memory 208, the processing time of the processor 212 dedicated to various applications being executed by the processor 212, and the peripheral devices, as well as performing other functionality. In this manner, the operating system 216 serves as the foundation on which applications, such as the broadcast channel management function 218, depend as is generally known by those with ordinary skill in the art.

The memory 208 may store a broadcast channel management function 218. The broadcast channel management function 218 may be embodied as one or more computer programs (e.g., one or more software applications including compilations of executable code).

The broadcast channel management function 218 may be configured to identify accessible channels on which content is provided over licensed and/or unlicensed spectrum at the location of the wireless electronic device without having to perform a scanning and identification process. For example, the broadcast channel management function 218 may request and receive a list of accessible channels and associated channel numbers from the server 102. The request may include information stored in the memory 208 of the wireless electronic device 200, such as the location of the wireless electronic device, identification of the wireless electronic device, specification(s) of the wireless electronic device, etc. The list received in response to the request may include information about each accessible channel, such as the associated broadcast band (frequency) and associated channel number. The list may include additional information about each accessible channel, such as network affiliation, genre, type of broadcast (e.g., licensed spectrum, unlicensed spectrum, mobile TV standard, or fixed TV standard), bibliographic information (e.g., name of the content being broadcast, length, description) etc. The memory 108 of the wireless electronic device 108 may store the list of accessible channels and associated channel numbers.

The broadcast channel management function 118 may use the list of accessible channels and associated channel numbers as a channel map for a given location. Alternatively, the broadcast channel management function 18 may generate a channel map by assigning a user-defined channel number to one or more of the accessible channels. Such assignment may be based on one or more conditions relating to the attributes of the accessible channel. In an example, a user may define an accessible channel affiliated with a specific broadcasting resource (e.g., NBC CNN, BBC, etc.) with a user-defined channel number (e.g., channel 2). The memory 108 of the wireless electronic device 108 may store the channel map.

In other embodiments, the broadcast channel management function 218 may be configured to identify a channel by which the wireless electronic device may receive content from a content management device using localized broadcast. For example, the broadcast channel management function 218 may request and receive the identity of a channel on which the content is to be broadcast to the wireless electronic device.

Exemplary embodiments showing the operation of the broadcast channel management function 218 are described in more detail below.

The electronic device 200 may include a display 224. The display 224 displays information to a user such as operating state, time, telephone numbers, contact information, various menus, etc., that enable the user to utilize the various features of the electronic device 200. The display 224 also may be used to visually display content received by the electronic device 200. The display 224 may be used to present images, video and other graphics to the user, such as photographs, television content, mobile television content, Internet pages, and video associated with games. The display 224 may be coupled to the control circuit 210 by a video processing circuit 226 that converts video data to a video signal used to drive the display 224. The video processing circuit 226 may include any appropriate buffers, decoders, video data processors and so forth. The video data may be derived from an incoming video data stream that is received by the communications circuitry 202.

The wireless electronic device 200 may include a sound signal processing circuit 228 for processing audio signals received from the communications circuitry 202. Coupled to the sound signal processing circuit 228 is a speaker 230 that enables a user to listen to audio data received by the wireless electronic device 200. The audio data may include, for example, received audio data such as in the form of streaming audio data. The sound signal processing circuit 228 may include any appropriate buffers, decoders, encoders, amplifiers and so forth. A microphone 220 also may be operatively coupled to the control circuit 210 via the sound signal processing circuit 228.

The wireless radio device 200 may have various video and input/output (I/O) interfaces 232. The (I/O) interfaces 232 may be used to operatively couple the wireless radio device 200 to various peripherals (not shown), such as a display, a keyboard, a mouse, other input devices, a microphone, a camera, a scanner, a printer, a speaker, a power supply, and so forth.

The wireless electronic device may include a position data receiver, such as a global positioning system (GPS) receiver 234. In one embodiment, location of the wireless radio device 200 may be determined using a triangulation method. A common triangulation method is by using a GPS or assisted GPS (AGPS) approximation of location.

FIG. 7 is a schematic view of an exemplary content management device 300 illustrated in FIG. 5. As discussed in more detail below, the content management device 300 may be configured to transmit a resource request to the server, and receive a resource response from the server including identification of an available broadcast resource proximate the location of a wireless electronic device. Such features allow for the content management device to identify an available broadcast resource (e.g., a transmitter and spectrum) through which the content management device may effectuate broadcast of content to the wireless electronic device.

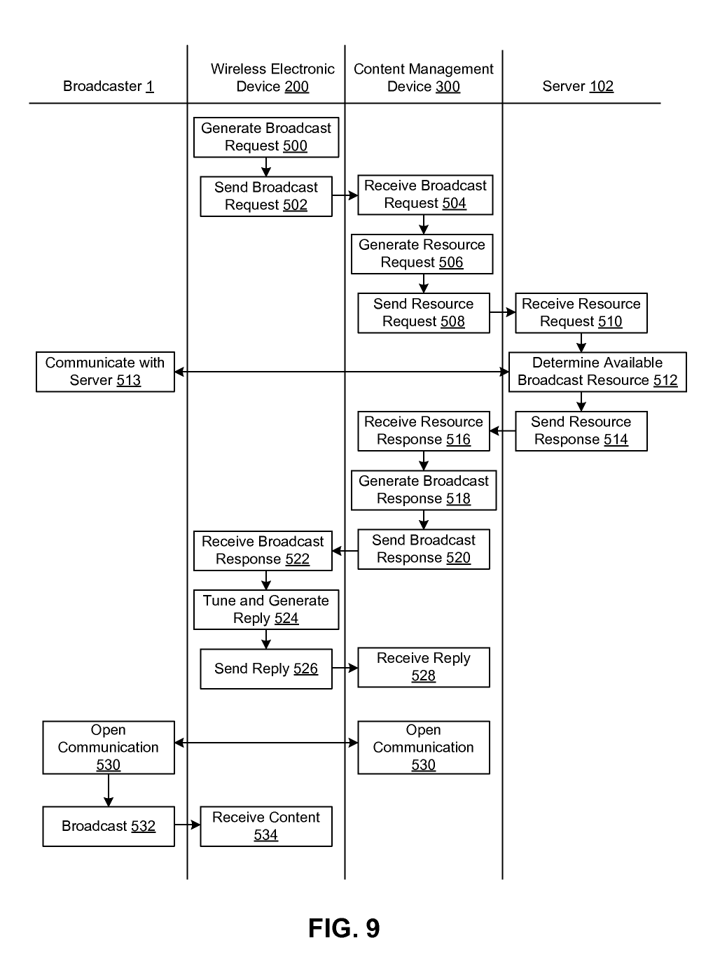

The content management device 300 may have various video and input/output (I/O) interfaces 302 as well as one or more communications interfaces 304. The I/O interfaces 302 may be used to operatively couple the content management device 300 to various peripherals (not shown), such as a display, a keyboard, a mouse, and/or one or more other suitable input devices. The communications interfaces 304 may include for example, a modem and/or a network interface card. The communications interfaces 304 may enable the content management device 300 to send and receive data signals, voice signals, video signals, and the like to and from the server 102, the wireless electronic device 200, and/or a broadcaster 400 (FIG. 9) via the external network 208.

The content management device 300 may include a memory 306 for storing data, logic routine instructions, computer programs, files, operating system instructions, and the like. The memory 306 is considered a non-transitory computer readable medium and may comprise several devices, including volatile and non-volatile memory components. Accordingly, the memory 306 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the content management device 300 may be controlled by a control circuit 308. The control circuit 308 may include one or more processors 310 used to execute instructions that carry out a specified logic routine(s). The control circuit 308 and the components of the memory 306 may be coupled using a local interface 312. The local interface 312 may be, for example, a data bus with accompanying control bus, a network, or other subsystem.

The memory 306 may store an operating system 314 that is executed by the processor 310 to control the allocation and usage of resources in the content management device 300, as well as provide basic user interface features. Specifically, the operating system controls the allocation and usage of the memory 306, the processing time of the processor 310 dedicated to various applications being executed by the processor 310, and the peripheral devices, as well as performing other functionality. In this manner, the operating system 314 serves as the foundation on which applications, such as the broadcast resource request function 316, depend as is generally known by those with ordinary skill in the art. The operating system 314 also may control much of the user interface environment presented to a user, such as features of the overall graphical user interface (GUI) for the system.

The memory 306 may store broadcast resource request function 316. The broadcast resource request function 316 may be embodied as one or more computer programs (e.g., one or more software applications including compilations of executable code).

The broadcast resource request function 316 may be configured provide a wireless electronic device with content using localized broadcast. For example, the broadcast channel management function 218 may request and receive from the server 102 the identity of a broadcast resource proximate the location of a wireless electronic device that has the capability and capacity to broadcast the content to the wireless electronic device. The broadcast resource request function 316 may be configured to request the identity of an available broadcast resource in response to a request from the wireless electronic device 200 to receive content. The request from the content management device to the server may include information provided by the wireless electronic device 200, such as the location of the wireless electronic device, identification of the wireless electronic device 200, specification(s) of the wireless electronic device 200, etc. The response from the server to the content management device may include information regarding the broadcast resource, such as the associated broadcast band (frequency), associated channel number, broadcaster associated with the broadcast resource, etc.

In response to receiving the identity of an available broadcast resource from the server 102, the broadcast resource request function 316 may transmit a broadcast response to the wireless electronic device 200, which includes identification of a channel on which the content is to be broadcast to the wireless electronic device 200 via the available broadcast resource. The broadcast resource request function 316 may open communication with the broadcaster associated with the available broadcast resource to effectuate broadcast of the content to the wireless electronic device 200. Exemplary embodiments showing the operation of the broadcast resource request function 316 are described in more detail below.

### C. EXEMPLARY EMBODIMENTS OF BROADCAST RECEPTION MANAGEMENT

The following description provides exemplary embodiments by which broadcast reception management may be executed. These exemplary embodiments may be carried out, in part, by executing an embodiment of the broadcast channel determination function 114 of the server 102, an embodiment of the broadcast channel management function 218 of the wireless electronic device 200, an embodiment of the broadcast resource determination function 116 of the server 102, and/or an embodiment of the broadcast resource request function 316 of the content management device 300. Therefore, the following exemplary embodiments represent one or more methods that may be carried out by the server 102, one or more methods that may be carried out by the wireless electronic device 200, and one or more methods that may be carried out by the content management device 300. Although the exemplary embodiments show specific orders of executing functional logic blocks, the order of executing the blocks may be changed relative to the order shown. Also, two or more blocks shown in succession may be executed concurrently or with partial concurrence. Furthermore, one or more of the functional logic blocks may be omitted.

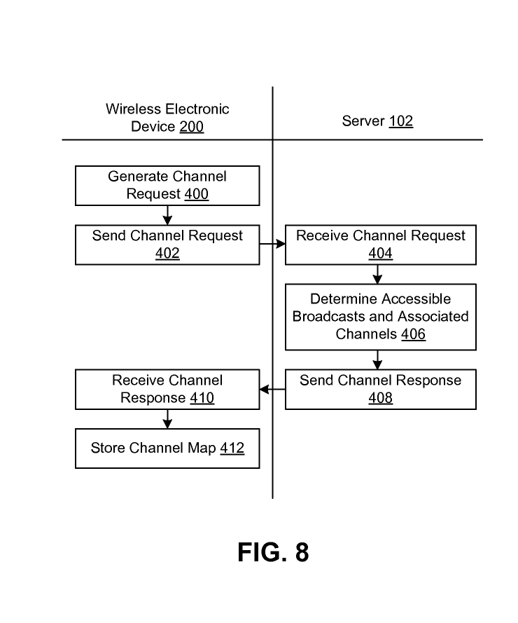

FIG. 8 shows an exemplary embodiment of broadcast reception management. In accordance with the exemplary embodiment, a database may provide information for advising the wireless electronic device of the accessible channels on which content is provided over licensed and/or unlicensed spectrum for a given location, as well as the associated channel numbers for the channels. The wireless electronic device may identify the accessible channels and associated channel numbers for a given location without having to perform the scanning and identification process.

The broadcast management process may commence in block 400 where the broadcast channel management function 218 of the wireless electronic device 200 generates a channel request. The channel request may include the location of the wireless electronic device. The channel request may additionally include information such as identification of the wireless electronic device 200, specification(s) of the wireless electronic device 200, etc.

The broadcast channel management function 218 may generate the channel request upon the occurrence of a trigger condition. Such trigger condition presents a likelihood that the wireless electronic device has been moved to a new location that includes new and/or different accessible channels. In some embodiments, generation of the channel request may be triggered each time the wireless electronic device 200 is powered on, or after a predetermined amount of time. In other embodiments, generation of the channel request may be triggered by a change in the geographic location of the wireless electronic device. For example, the location of the wireless electronic device may be determined using the GPS of the wireless electronic device 100. Every time the wireless electronic device moves a specified distance, the broadcast channel management function 218 may generate the channel request. In still other embodiments, the broadcast channel management function 218 may generate the channel request upon user initiation.

At step 402, the broadcast channel management function 218 of the wireless electronic device 200 may send the request to the server 102. At step 404, the request may be received at the server 102.

At step 406, the broadcast channel determination function 114 of the server 102 may determine a list of accessible channels and associated channel numbers for the location of the wireless electronic device 200. The broadcast channel determination function 114 searches the database stored on the server 102 for channels capable of being received by the wireless electronic device 200 in its present location. The broadcast channel determination function 114 may use the information included in the channel request (e.g., the location of the wireless electronic device, identification of the wireless electronic device 200, specification(s) of the wireless electronic device 200, antenna gain, etc.), as well as information included in the database (e.g., geographic coverage area, data regarding transmission characteristics of the transmitter, etc.) to determine which channels are accessible by the wireless electronic device. The determination may be based on predicted signal strength of the broadcasts at the location of the wireless electronic device 200 and/or the location of the wireless electronic device 200 being within a known coverage area of the corresponding transmitter(s). Predicted signal strength may be determined using any appropriate path loss model, such as Longley-Rice, F-curves, etc.

As a result of the determination performed by the broadcast channel determination function 114, a list of accessible channels and associated channel numbers for the location of the wireless electronic device 200 may be generated. Each accessible channel may be associated with a respective channel number. Each accessible channel may additionally be associated with other information, such as network affiliation, genre, type of broadcast (e.g., licensed spectrum, unlicensed spectrum, mobile TV standard, or fixed TV standard), bibliographic information, etc.

At step 408, the broadcast channel determination function 114 of the server 102 may send the channel response to the wireless electronic device 200. The channel response may include the list of accessible channels and associated channel numbers, as well as any other additional information as described above. At step 410, the channel response may be received at the wireless electronic device 200. The list of accessible channels and associated channel numbers may be stored in the memory 208 of the wireless electronic device 200.

At step 412, the broadcast channel management function 218 of the wireless electronic device may store a channel map 412 associated with the list of accessible channels and associated channel numbers received from the server 102. In some embodiments, the list of accessible channels and associated channel numbers is stored and used as the channel map. In other embodiments, the broadcast channel management function may generate the channel map by assigning a user-defined channel number to one or more of the accessible channels identified in the list. Such assignment may be based on one or more conditions relating to the attributes of the accessible channel. The user of the wireless electronic device may create a user-defined virtual channel number for the accessible channel, which supersedes the channel number identified in the list as being associated therewith. For example, a user may define an accessible channel affiliated with NBC as channel 2, regardless of the associated channel number identified in the list of accessible channels and associated channel numbers.

The channel map may be used by the wireless electronic device 200 as a listing of available channels at the location of the wireless electronic device. The channel map may be used in place of a list of available channels determined using the conventional scanning and identification process. The channel map may be displayed (e.g., on the display 224 of the wireless electronic device 200), and a user may browse the channel map to find content that the user desires to watch (e.g., similar to a TV guide). The channel map may be stored in the memory 208 of the wireless electronic device 200.

FIG. 9 shows another exemplary embodiment of broadcast reception management. In accordance with the exemplary embodiment, a database may provide information for advising a content management device of an available broadcast resource (e.g., a transmitter and spectrum) through which the content management device may effectuate broadcast of content to the wireless electronic device. The wireless electronic device may receive content (e.g., on-demand content or permission-based content) from a content management device using localized broadcast.

The broadcast management process may commence in block 500 where the broadcast channel management function of the wireless electronic device 200 may generate a broadcast request. The broadcast request may include the location of the wireless electronic device 200. The broadcast request may additionally include information such as identification of the wireless electronic device 200, specification(s) of the wireless electronic device 200, etc.

The broadcast channel management function 218 of the wireless electronic device 200 may generate the broadcast request in connection with a request for access to on-demand and/or permission-based content. In an example, the request may be for permission-based programming broadcast using private network equipment on TVWS channels, licensed channels, or other channels on which free or unrestricted access is not required by governing regulation, but that the device has permission to access, such as through a subscription or pay-per-view. Accordingly, the broadcast request may include authentication information (e.g., stored on the memory 208 of the wireless electronic device 200). For example, the broadcast request may additionally include an authenticated data object, e.g., a digital key stored in the database 208 of the wireless electronic device 200.

At step 502, the broadcast channel management function 218 of the wireless electronic device may send the broadcast request to the content management device 300. At step 504, the broadcast request may be received at the content management device 300. In those embodiments where the broadcast request includes an authenticated data object, the broadcast resource management function 316 of the content management device 300 may use such object to authenticate the wireless electronic device 200.

At step 506, the broadcast resource management function 316 of the content management device 300 may generate a resource request. The broadcast resource management function 316 may generate the resource request as a result of receiving the broadcast request from the wireless electronic device 200. The broadcast request may include information provided to the content management device 300 by the wireless electronic device 200, such as the location of the wireless electronic device 200, identification of the wireless electronic device 200, specification(s) of the wireless electronic device 200, etc.

At step 508, the broadcast resource management function 316 of the content management device 300 may send the resource request to the server 102. At step 510, the resource request may be received at the server 102.

At step 512, the broadcast resource determination function 116 of the server 102 may determine an available broadcast resource and associated spectrum proximate the location of the wireless electronic device 200. The broadcast resource determination function 116 may search the database stored on the server 102 for available broadcast resources having the capability and capacity to broadcast content to the wireless electronic device 200 in its present location. The broadcast resource determination function 114 may use the information included in the resource request (e.g., the location of the wireless electronic device, identification of the wireless electronic device 200, specification(s) of the wireless electronic device 200, etc.), as well as information included in the database pertaining to the available broadcast resources (e.g., location, geographic coverage area, channel number or sub-channel, data regarding transmission characteristics of the transmitter, associated broadcaster, etc.) to determine which broadcast resource is most suitable. The determination may be based on predicted signal strength at the location of the wireless electronic device 200 and/or the location of the wireless electronic device 200 being within a known coverage area of the broadcast resource(s). Predicted signal strength may be determined using any appropriate path loss model, such as Longley-Rice, F-curves, etc. In some embodiments, more than one available broadcast resource may be suitable. In such embodiments, the more suitable broadcast resource may be determined based on such factors as the type or location of transmitter, channel available, predicted signal strength at the location of the wireless electronic device 200, etc.

The broadcast resource determination function 116 of the server 102 may communicate with one or more broadcasters 1 to ascertain which broadcast resources are available for broadcasting content to the wireless electronic device. In some embodiments, the broadcast resource determination function 116 of the server 102 may periodically contact the broadcasters 1 and receive such information. This periodic contact may be independent from an inquiry from the content management device 300. For example, the broadcast resource determination function 116 of the server 102 may contact the broadcasters 1 once per day. In other embodiments, as shown in step 513, the broadcast resource determination function 116 of the server 102 may communicate with the broadcaster 1 in connection with the determination of available broadcast resources (e.g., in connection with step 512). The broadcast resource determination function 116 of the server 102 may negotiate use of the available broadcast resources with the broadcaster 1.

At step 514, the broadcast resource determination function 116 of the server may send a resource response to the content management device 300. The resource response may include the identification of an available broadcast resource and associated spectrum proximate the location of the wireless electronic device. The resource response may additionally include information such as identification of the broadcaster 1 associated with the broadcast resource, IP address of the available broadcast resource, any terms (e.g., payment terms, time limit), communication protocol, bandwidth, etc. At step 516, the resource response may be received at the content management device 300. The identification of the available broadcast resource and associated spectrum proximate the location of the wireless electronic device may be stored in the memory 306 of the content management device 300.

At step 518, the broadcast resource management function 316 of the content management device 300 may generate a broadcast response. The broadcast response may include the channel (spectrum) associated with the available broadcast resource (more specifically, the channel to which the wireless electronic device should tune to receive the content). The broadcast response may further include a decryption key for decrypting the content. At step 520, the broadcast resource management function 316 of the content management device 300 may send the broadcast response to the wireless electronic device 200. At step 522, the broadcast response may be received at the wireless electronic device 200.

At step 524, the broadcast channel management function 218 of the wireless electronic device 200 may tune the wireless electronic device 200 to the associated spectrum included in the broadcast response. The spectrum may be associated with an actual or virtual channel. In some embodiments, the channel may be defined by the user of the wireless electronic device 200. The broadcast channel management function 218 may also generate a reply indicating that the wireless electronic device 200 is tuned to the channel. At step 526, the broadcast channel management function 218 of the wireless electronic device 200 may send the reply to the content management device. At step 528, the reply may be received at the content management device 300.

At step 530, the broadcast resource management function 316 of the content management device 300 may open communication between the content management device 300 and the broadcaster 1 associated with the available broadcast resource. At step 532, the broadcaster 1 may broadcast the content over the associated spectrum. At step 534, the wireless electronic device 200 may receive the content. The broadcasted content may be encrypted. Accordingly, decryption may involve use of an authenticated data object, e.g., a digital key stored in the memory 208 of the wireless electronic device.

In some embodiments, the content may be broadcast to the wireless electronic device 200 for consumption/viewing in real time (e.g., using the digital TV or mobile TV standard protocol). In other embodiments, the content may be broadcast and downloaded for storage consumption/viewing at a later time.

### D. CONCLUSION

Although certain embodiments have been shown and described, it is understood that equivalents and modifications falling within the scope of the appended claims will occur to others who are skilled in the art upon the reading and understanding of this specification.

1.-15. (canceled)

16. A wireless electronic device, comprising:
communications circuitry configured to communicate with a content management device and to tune to a broadcast; and
control circuitry that executes a broadcast channel management function configured to:
transmit a broadcast request to the content management device to request a broadcast of content over available spectrum at a location of the wireless electronic device, the broadcast request comprising the location of the wireless electronic device;
receive a broadcast response from the content management device, the broadcast response comprising identification of an identified available spectrum channel on which the content will be broadcast to the wireless electronic device from an available broadcast resource proximate the location of the wireless device; and
tune the communications circuitry to the identified available spectrum channel to receive the content from the available broadcast resource.

17. The wireless electronic device of claim 16, wherein the broadcast request further comprises at least one of an identity of the wireless electronic device or one or more specifications of the wireless electronic device.

18. The wireless electronic device of claim 16, wherein the identified available spectrum channel is associated with one of licensed spectrum or unlicensed spectrum.

19. The wireless electronic device of claim 16, wherein content is received via the identified available spectrum channel from a broadcaster that has communicated with the content management device.

20. A content management device, comprising:
communications circuitry configured to communicate with a wireless electronic device and with a server; and
control circuitry that executes a broadcast resource management function configured to:
receive a broadcast request from the wireless electronic device to request a broadcast of content over available spectrum at a location of the wireless electronic device;
transmit a resource request to a server to identify an available broadcast resource proximate the wireless electronic device to broadcast the content to the wireless electronic device over an identified available spectrum channel, the resource request comprising the location of the wireless electronic device;
receive a resource response from the server, the resource response comprising identification of the available broadcast resource proximate the location of the wireless electronic device and of the identified available spectrum channel, the available broadcast resource having the capability and capacity to broadcast the content to the wireless electronic device over the identified available spectrum channel; and
transmit a broadcast response to the wireless electronic device, the broadcast response comprising the identification of the identified available spectrum channel.

21. The content management device of claim 20, wherein the resource request further comprises at least one of an identity of the wireless electronic device or one or more specifications of the wireless electronic device.

22. (canceled)

23. The content management device of claim 20, wherein the broadcast request further comprises at least one of an identity of the wireless electronic device or one or more specifications of the wireless electronic device.

24. (canceled)

25. The content management device of claim 20, wherein the broadcast response further comprises a decryption key configured to decrypt the content.

26. The content management device of claim 20, wherein the broadcast resource management function is further configured to receive a reply from the wireless electronic device in response to transmitting the broadcast response, the reply indicating that the wireless electronic device is prepared to receive the content.

27. The content management device of claim 20, wherein:
the communications circuitry is further configured to communicate with a broadcaster; and
the broadcast resource management function is further configured to open communication between the content management device and the broadcaster to broadcast the content via the available broadcast resource to the wireless electronic device.

28. The content management device of claim 27, wherein the content is encrypted.

29. A server, comprising:
communications circuitry configured to communicate with a content management device;
a memory storing a database comprising a list of available broadcast resources configured to broadcast content to a wireless electronic device, each available broadcast resource associated with a coverage area;
control circuitry that executes a broadcast resource determination function configured to:
receive a resource request from the content management device to identify an available broadcast resource proximate the wireless electronic device to broadcast content to the wireless electronic device over available spectrum at a location of a wireless electronic device, the resource request comprising the location of the wireless electronic device; and
identify the available broadcast resource proximate the location of a wireless electronic device from the list of available broadcast resources and an available spectrum channel at the location of the wireless electronic device; and
transmit a resource response to the server, the resource response comprising the identification of the available broadcast resource proximate the location of the wireless electronic device and the identified available spectrum channel.

30. The server of claim 29, wherein the resource request further comprises at least one of an identity of the wireless electronic device or one or more specifications of the wireless electronic device.

31. The server of claim 29, wherein the database comprises at least one of an available broadcast resource configured to broadcast content using licensed spectrum and an available broadcast resource configured to broadcast content using unlicensed spectrum.

32. The server of claim 29, wherein:
the communications circuitry is further configured to communicate with a broadcaster; and
the broadcast resource determination function is further configured to negotiate with the broadcaster to arrange use of the broadcast resource on behalf of the content management device.

33. The wireless electronic device of claim 16, wherein the content is on-demand or permission-based content.

34. The wireless electronic device of claim 16, wherein the broadcast request further comprises authentication information.

35. The wireless electronic device of claim 16, wherein the content received at the wireless electronic device is encrypted.

36. The wireless electronic device of claim 35, wherein the broadcast response further comprises a decryption key for decrypting the content.

37. The content management device of claim 20, wherein the content is on-demand or permission-based content.

38. The content management device of claim 20, wherein the broadcast request further comprises authentication information.

39. The server of claim 29, wherein the content is on-demand or permission-based content.
